(19) United States
(12) Patent Application Publication
(10) Pub. No.: US 2013/0142640 A1
(43) Pub. Date: Jun. 6, 2013

(54) ALTERNATE SHROUD WIDTH TO PROVIDE MISTUNING ON COMPRESSOR STATOR CLUSTERS

(71) Applicants: David P. Houston, Glastonbury, CT (US); Richard A. Lomenzo, Enfield, CT (US); Robert J. Morris, Portland, CT (US)

(72) Inventors: David P. Houston, Glastonbury, CT (US); Richard A. Lomenzo, Enfield, CT (US); Robert J. Morris, Portland, CT (US)

(21) Appl. No.: 13/309,685

(22) Filed: Dec. 2, 2011

(51) Int. Cl. F01D 9/02; B23P 15/04

(52) U.S. Cl. 415/208.2; 29/889.22

(57) ABSTRACT

A stator for a turbo-machine having a plurality of airfoils extending radially therefrom has a base from which the airfoils depend, and slits disposed in the base, each slit disposed adjacent a pair of airfoils, wherein a first set of adjacent slits and a distance between a second set of adjacent slits varies

### BACKGROUND

Gas turbine engines include alternating stages of rotating blades and stationary vanes. Each vane stage comprises a plurality of stator segments. A segment could include a plurality of vanes extending between an outer platform and an inner platform. Stator segments are commonly formed by casting or by brazing.

To relieve any build-up of stress caused by temperature gradients in the vanes and platforms during engine operation, the inner platform typically includes relief slits between adjacent vanes. These relief slits also help isolate vanes from vibration modes of adjacent vanes. The stator segment also includes a damper to reduce vibration amplitudes, thereby helping prevent vane cracking.

### SUMMARY

According to an embodiment shown herein, stator for a turbo-machine having a plurality of airfoils extending radially therefrom has a base from which the airfoils depend, and slits disposed in the base, each slit disposed adjacent a pair of airfoils, wherein first set of adjacent slits and a distance between a second set of adjacent slits varies.

According to a further embodiment shown herein, a gas turbine engine stator having a plurality of airfoils depending radially inwardly therefrom has a base from which the airfoils depend, and slits disposed in the base, each slit disposed between a pair of airfoils, first set of adjacent slits and a distance between a second set of adjacent slits varies.

According to a still further embodiment shown herein, method for creating a stator having a plurality of blades depending therefrom includes the steps of designing slits, each slit disposed between a set of adjacent blades, wherein the slits have varying distances therebetween wherein a first area between a first set of the slits has a first frequency mode that is not in tune with a second area between a second set of the slits having a second frequency mode, and creating the slits within the stator.

Although different examples have the specific components shown in the illustrations, embodiments of this invention are not limited to those particular combinations. It is possible to use some of the components or features from one of the examples in combination with features or components of another of the examples.

These and other features disclosed herein can be best understood from the following specification and drawings, the following of which is a brief description.

### BRIEF DESCRIPTION OF THE DRAWINGS

FIG. 1 is a schematic view of a gas turbine engine that incorporates an embodiment disclosed herein.

FIG. 2 is a top, segmented, view of a portion of FIG. 1 taken along the lines 2-2.

FIG. 3 is a bottom view of FIG. 2.

FIG. 4 shows a method of determining spacing within the embodiment shown in FIGS. 2 and 3.

### DETAILED DESCRIPTION

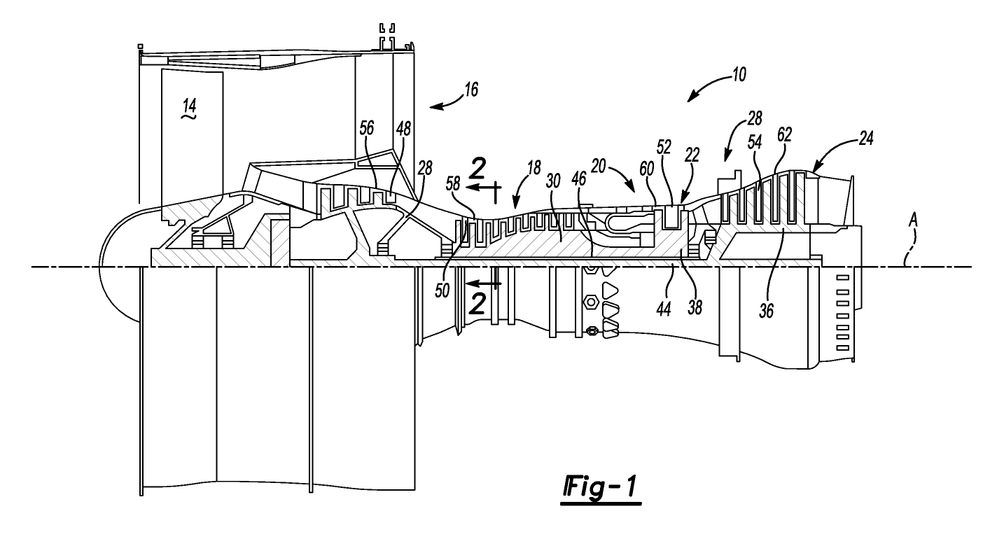

Referring to FIG. 1, an example turbo-machine, such as a gas turbine engine 10, is circumferentially disposed about an axis A. The gas turbine engine 10 includes a fan 14, a low pressure compressor section 16, a high pressure compressor section 18, a combustion section 20, a high pressure turbine section 22, and a low-pressure turbine section 24. Other example turbo-machines may include more or fewer sections and different arrangements.

During operation, air is compressed in the low pressure compressor section 16 and the high pressure compressor section 18. The compressed air is then mixed with fuel and burned in the combustion section 20. The products of combustion are expanded across the high pressure turbine section 22 and the low pressure turbine section 24.

The low pressure compressor section 16 and the high pressure compressor section 18 include low pressure rotors 28 and high pressure rotors 30, respectively. The high pressure turbine section 22 and the low pressure turbine section 24 each include high pressure rotors 36 and low pressure rotors 38, respectively. The rotors 36 and 38 rotate in response to the expansion to rotatably drive the high pressure compressor section 18 and the low pressure compressor section 16.

The rotor 36 is coupled to the low pressure rotor 28 with a spool 44, and the rotor 38 is coupled to the rotor 30 with a spool 46. Bearings rotatably support the spools 44 and 46 during operation of the gas turbine engine 10.

A plurality of vanes, for instance, low pressure compressor vanes 48, high pressure compressor vanes 50, high pressure turbine vanes 52 and low pressure turbine blades 54 are interspersed between the rotors 28, 30, 36, 38 to direct air as it passes between sections of the engine 10. The blades may also be referred to as airfoils.

The examples described in this disclosure are not limited to the two-spool gas turbine architecture described, however, and may be used in other architectures, such as the single-spool axial design, a three-spool axial design, and still other architectures. That is, there are various types of gas turbine engines, and other turbo-machines, that can benefit from the examples disclosed herein.

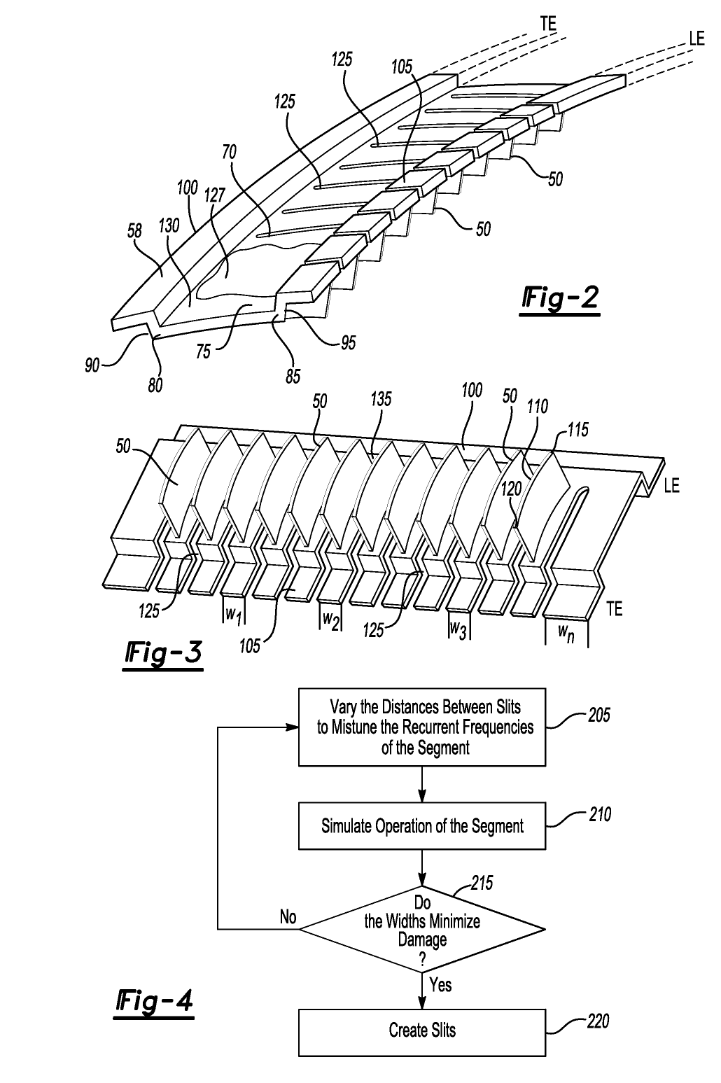

Referring now to FIGS. 2 and 3, an example stator 56 has a plurality of segments 70 (one of which is shown in FIG. 2) that abut each other to form a ring (shown in FIG. 1). An example stator 56 may have seven or eight such segments 70 connected end-to-end to each other. Each segment has a radially curved base 75 having forward end 80 and aft end 85. A forward side wall 90 and an aft sidewall 95 each extend radially upwardly from forward end 80 and aft end 85 of the base 75 respectively. Forward brim 100 extends forward axially from side wall 90 and aft brim 105 extends aft from side wall 95 such that the brims 100, 105 do not extend over the base 75. A sheet (not shown), usually made of a shaped metal, may be placed against the base 75 between the sidewalls 90, 95 to damp structural vibrations in the segments.

Depending downwardly from the base 75, a plurality of vanes 50 (e.g., blades or airfoils) extend. The vanes 50 and the segment 70 may be formed together as clusters to minimize the costs of manufacturing a segment. The vanes 50 have a curved cross-sectional shape 110 that is contained on the base 75. Each vane 50 has a forward end portion 115 and an aft end portion 120. The vanes 50 may be angled relative to Axis A as may be required by the requirements of the engine 10.

It has been discovered by the Applicants herein, that a segment 70 made in a cluster and that has multiple vanes or airfoils may have very similar vibratory modes to other segments, which can result in resonance or mistuning that could shorten the life of a segment. Harmonious vibratory modes may be destructive to a lifespan of a segment 70.

Between each vane 50, a slit 125 is disposed (e.g., cut or formed or the like) that extends through aft brim 105, aft side wall 95 and into the base 75 at an angle corresponding to the disposition of the vanes 50 from the base 75. The slits 125 are not regularly spaced and the distance or widths W between slits 125 differ. For instance width W (including an area including a vane/airfoil and a piece of the base 75) may be different from width W₂ or width W₃ or width Wₙ. The depth of each slit 125 may vary though they may extend to the forward end portion 115 of the airfoil/vane 50. The width of each slit 125 may also vary though they may be kept uniform for ease of construction. The slits 125 may be filled with a damping material 127 such as an elastomer or the like, which may further limit vibratory modes and act to minimize the flow of air through the slits 125. The slits 125 may also be mechanically blocked by a damping sheet 127 (see FIG. 2) or the like. The slits 125 extend radially through the base 75 from a top 130 to a bottom 135 thereof. There may be a slit 125 between or adjacent to each vane 50. The slits 125 may be skewed relative to each other to improve the (dis)harmonics of each width W.

Though the segment 70 demonstrated herein is used in the high pressure compressor section 18 of the engine 10, one of ordinary skill in the art recognizes that the teachings herein may be used in other sections of the engine 10.

Referring now to FIG. 4, a method of creating a segment using widths Wₙ is shown. The varying widths/distance Wₙ that create discordant resonant frequencies are determined that deliberately mistune each width relative to other widths (step 205), operation of the segment 70 with varied widths is simulated (step 210), the efficacy of chosen widths as to the life of the segment 70 (e.g., minimize damage to the segment 70) in reaction to the chosen widths Wₙ is determined (step 215) and the slits are created if appropriate (step 220). In essence, each width is a tuning fork with given vibratory modes that might combine with other modes that may damage the segment 70. By varying each width Wₙ and each width's attendant vibratory modes thereby, a non-destructive discordance is created.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A stator for a turbo-machine having a plurality of airfoils extending radially therefrom, said stator comprising:
a base from which said airfoils extend, and
slits disposed in said base, each slit disposed adjacent a pair of airfoils,
wherein a distance between a first set of adjacent slits and a distance between a second set of adjacent slits varies.

2. The stator of claim 1 wherein one of said slits is disposed adjacent each airfoil.

3. The stator of claim 1 wherein one of said slits is disposed between each airfoil.

4. The stator of claim 1 wherein each distance includes a portion of said base and an airfoil.

5. The stator of claim 4 wherein each distance has a resonant frequency during use.

6. The stator of claim 5 wherein said resonant frequencies vary to prolong life of said stator.

7. The stator of claim 1 wherein one of said slits extends through an aft end of said base towards a forward end of said base.

8. The stator of claim 7 wherein said one of said slits extends to a forward end of said airfoil.

9. The stator of claim 1 wherein one of said slits is filled to minimize air loss through said slit.

10. The stator of claim 9 wherein said slit is filled with an elastomer.

11. A gas turbine engine stator having a plurality of airfoils depending radially inwardly therefrom, said stator comprising:
a base from which said airfoils depend, and
slits disposed in said base, each slit disposed between a pair of airfoils,
wherein a distance between a first set of adjacent slits and a distance between a second set of adjacent slits varies.

12. The stator of claim 11 wherein each distance includes a portion of said base and a portion of an airfoil that have a resonant frequency during use.

13. The stator of claim 12 wherein said resonant frequencies vary to prolong life of said stator.

14. The stator of claim 11 wherein one of said slits extends through an aft end of said base towards a forward end of said base.

15. The stator of claim 11 wherein one of said slits extends to a forward end of said airfoil.

16. The stator of claim 11 wherein one of said slits is filled to minimize air loss through said slit.

17. The stator of claim 16 wherein said slit is filled with an elastomer.

18. A method for creating a stator having a plurality of blades depending therefrom, said method comprising:
designing slits, each slit disposed between a set of adjacent blades, wherein said slits have varying distances therebetween wherein a first area between a first set of said slits has a frequency mode that is not in tune with a second area between a second set of said slits having a second frequency mode, and
creating said slits within said stator.
